(19) United States
(12) Patent Application Publication
(10) Pub. No.: US 2004/0237540 A1
(43) Pub. Date: Dec. 2, 2004

(54) Co-generation system and a dehumidification air-conditioner

(75) Inventors: Hiroshi Okano, Koga-city (JP); Yukito Kawakami, Koga-city (JP); Mototsugu Nagamatsu, Koga-city (JP)

Correspondence Address: STAAS & HALSEY LLP, SUITE 700, 1201 NEW YORK AVENUE, N.W., WASHINGTON, DC, 20005, US

(73) Assignee: SEIBU GIKEN CO, LTD., Fukuoka (JP)

(21) Appl. No.: 10/686,711

(22) Filed: Oct. 17, 2003

Related U.S. Application Data
(62) Division of application No. 09/962,221, filed on Sep. 26, 2001, now abandoned.

(30) Foreign Application Priority Data
Oct. 31, 2000 (JP) 2000-333463
Sep. 26, 2000 (JP) 2000-291591
Mar. 2, 2001 (JP) 2001-58966

(51) Int. Cl. F25D 23/00; F02C 6/04

(52) U.S. Cl. 60/784; 62/271

(57) ABSTRACT

A co-generation system and a dehumidification air-conditioner, which generates electricity and provides highly efficient air-conditioning by reducing the latent heat load of the air-conditioner. Exhaust gas from either a turbine or an internal combustion engine heats air for desorption of adsorbed moisture from a humidity rotor. The humidity rotor has a sound adsorption material to attenuate high frequency noise coming from the exhaust outlet of the co-generation system.

### BACKGROUND OF THE INVENTION

1. Field of the Invention

An embodiment of the present invention relates to a dehumidification air-conditioner that works with an internal combustion engine co-generation system. Such a system generates electricity by combining an internal combustion engine with a dynamo, for example, a gas turbine co-generation system having a small gas turbine and a reciprocating engine, etc. Reciprocating engines are used with small dynamos of a size of about 30 kW-60 kW. By further using the waste heat of an internal combustion engine, the above-mentioned co-generation system is improved.

2. Description of the Related Art

In recent years, small gas turbines have been proposed as emergency power supplies, or as dynamos for co-generation. The reason is that the price of a small gas turbine is relatively low and also that it has a high degree of purity of exhaust gas etc. Moreover, gas turbine dynamos can provide continuous operation without requiring frequent maintenance.

Where small gas turbine dynamos are installed as emergency power supplies, they perform continuous operation. Under normal operating conditions, the small gas turbine dynamos through the power supply line supplies electric power. However during a power failure, the source of generation becomes exclusively the small gas turbine dynamo by momentarily switching to an emergency power supply line. Because gas turbines can take several minutes to start, gas turbine dynamos are operated continuously and electric power from the gas turbine dynamos therefore can be momentarily supplied to the emergency power supply line during a power failure.

Moreover, by normally supplying electric power from the small gas turbine to a power supply line, contract electric power with an electric power company is reduced, and ongoing cost reduction can be achieved.

FIG. 1 shows an example of the conventional small gas turbine dynamo. In a gas turbine unit 51, a turbine 53 is axially connected with a compressor 52, and the compressor 52 is provided to compress open air OA. Further, dynamo 54, which is connected along the axis of the turbine 53, generates torque therefrom.

Moreover, heat exchange is performed between the open air OA, which is compressed by the compressor 52, and the exhaust gas EA of the turbine 53. The air, which is sent to the turbine 53 from the compressor 52, is heated by the heat of the exhaust gas EA. A heat exchanger 55 is provided for raising the thermal efficiency of the gas turbine unit 51, which is about 30%.

Thermal efficiency is the ratio of the electric power generated with the dynamo 54 to the energy, which is supplied by the fuel, and is about 30%. Since the energy conversion efficiency of the gas turbine unit 51 is poor, a boiler 56 is provided, which collects the thermal energies from the exhaust gas as warm water. Synthetic energy efficiency is improved to about 70% by providing the boiler 56. Alternatively, an internal combustion engine co-generation system having an internal combustion engine can generate high thermal efficiency by further using the waste heat of an internal combustion engine.

That is, by using this exhaust gas as a heat source of a boiler in an internal combustion engine, in particular a gas turbine, a discharge of hot exhaust gas of 200° C. or more produces warm water. Therefore, although the electric energy obtained by power generation is generally between about 25%-35%, total energy efficiency becomes about 70% by using the heat of the exhaust gas for the supply of warm water etc.

As compared with the case where only the electric power from the dynamo is used, a markedly higher thermal efficiency can be achieved by supplying warm water. Since the dehumidification air-conditioner uses heat for dehumidification instead of using chlorofluocarbon, and since the heat is also a source of drive energy, the heat can be produced from a variety of energy sources, such as combustion gas heat, exhaust heat, or solar heat. Therefore, emission of carbon dioxide can be decreased, and also the electric power summer peak demand load can be reduced. Thus, the dehumidification air-conditioner has many features.

FIG. 2 and FIG. 3 show a conventional dehumidification air-conditioner. Blower 57 sends atmosphere (open air) OA to the adsorption zone 59 of the dehumidification rotor 58. The dehumidification rotor 58 turns air into dry air while air temperature increases due to adsorption heat. The dehumidification rotor 58 supports moisture absorption agents, such as silica gel and zeolite, on fibers (paper-like material) formed in the shape of honeycombs. The dehumidification rotor 58 is rotary driven through a rotation drive by a motor with a belt, etc. (not shown).

The dehumidification rotor 58 is formed as shown in FIG. 3. The air, which comes out of the adsorption zone 59 of the dehumidification rotor 58, passes the rotary type sensible-heat exchange element 60. The rotary type sensible-heat exchange element 60, which is also shown in FIG. 3, is formed in the shape of a honeycomb with thin sheets, such as aluminum, and is rotary driven through a rotation drive by a motor with, for example, a belt, etc. (not shown). The dry air coming out of the adsorption zone 59 and having an increased temperature performs heat exchange with the rotary type sensible-heat exchange element 60 in a cooling zone 61. Therefore, while the temperature of the dry air decreases, the temperature of the rotary type sensible-heat exchange element 60 increases. This air, which is dried and cooled, is supplied indoors as product air SA. Return air RA from the interior of a room is humidified and cooled by a spray 62. Humidity increases, and the air which was cooled passes the rotary type sensible-heat exchange element 60, and provides heat exchange with the rotary type sensible-heat exchange element 60 in the heating zone 63. While cooling the rotary type sensible-heat exchange element 60, the temperature of the return air RA increases. At a heater 64, temperature increases further, and the high-humidity air which increased in temperature because of the heat exchange with the rotary type sensible-heat exchange element 60 turns into high temperature air, and goes into a desorption zone 65 of the dehumidification rotor 58. Desorption of the adsorbed moisture from the dehumidification rotor 58 is carried out by this high temperature air, and the high temperature air is emitted to the atmosphere by the blower 66 as exhaust gas EA. Heater 64 can be, for example, an electric heater, a steam heater, etc.

In the above gas turbine co-generation systems, because of the high number of rotations of the gas turbine, which is set at 96,000 rpm, the small gas turbine has problems with high frequency noise emissions. If the gas turbine is put into a prevention-of-noise case, the sound pressure level of this noise at 1 meter drops to about 60 dbs, and is not large as an absolute value. The frequency of this noise is in the ultra sonic range (over 20,000 Hz) and can be about 38,000 Hz. Because of the high frequency content of the noise, it still feels very unpleasant to someone in the vicinity. Since the conventional gas turbine co-generation system provided continuous operations, when the overall noise decreases, such as at night, the high frequency noise is still a problem.

Further, although waste heat is collected in the boiler by generation of hot water as above-mentioned, a problem arises in that the hot water is not used during the summer, and therefore the recovery effect of waste heat is not achieved as a result.

### SUMMARY OF THE INVENTION

While the gas turbine co-generation system of an embodiment of the present invention uses a gas turbine as a source of power, noise tends to reduce energy efficiency: Also, it is difficult to raise further the thermal efficiency of the above-mentioned internal combustion engine co-generation systems.

Moreover, due to low summer usage of hot water, production of hot water supplied from the waste heat of an internal combustion engine has been eliminated. For this reason, the problem arises that only electric energy could be actually used. Therefore, thermal efficiency becomes generally between about 25%-35% overall. In particular, the internal combustion engine co-generation system of the second embodiment of the present invention is excellent in thermal efficiency, and tends to achieve a high energy efficiency.

Moreover, since a rotary type sensible-heat exchange element 10 is used for the above-mentioned dehumidification air-conditioners as the dry air cooling, a problem arises that a portion of the air humidified by the spray 12 is carried into the product air SA side of the rotary type sensible-heat exchange element 10. That is, the rotary type sensible-heat exchange element 10 is a honeycomb object in the form of an assembly of thin pipes (flutes). It performs heat exchange between the air, which passes through the inside of a flute, and the sheet that constitutes the honeycomb object. Low-temperature, high-humidity air passes through the inside of a flute in the heating zone 13. Further, low-temperature, high-humidity air remains in the flute immediately after moving to the cooling zone 11 from the heating zone 13.

The moisture from the low-temperature, high-humidity air mixes with the high temperature dry air, which passes through the cooling zone 11, and gives moisture to the high temperature dry air. For this reason, although the temperature of the air supplied decreased, humidity increased. A problem arises that the air is uncomfortable. In order to lower the heat from the heater 14 as much as possible and to increase energy efficiency, efforts are being paid to lower humidity of the dry air supplied by the dehumidification rotor 8. When moisture mixes into dry air in such a situation, a problem arises that the energy efficiency of the whole system decreased. The dehumidification air-conditioner of the present invention solves the above-mentioned problem, and enables it to supply air of a highly comfortable nature at high efficiency. The first embodiment of the gas turbine co-generation system of the present invention solves the above-mentioned problems by allowing exhaust gas of the gas turbine, after passing a honeycomb-like moisture adsorption agent, to be emitted to the atmosphere. The internal combustion engine co-generation system of the second embodiment of the present invention also solves the above-mentioned problems by equipping the inside of the dynamo connected with the internal combustion engine, and casing surrounding the internal combustion engine with cooling air of the internal combustion engine, and by mixing the cooling air with exhaust gas from the internal combustion engine to produce hot air for desorption of humidity adsorbent. Further, the dehumidification air-conditioner of the third embodiment of the present invention is equipped with the dehumidification rotor in which desorption is carried out by the heated air. The heat exchange element performs heat exchange between two flow paths by passing through one passage of the heat exchange element the air from the interior of a room, and, at the same time, by passing through another passage of the heat exchange element the air dried from the dehumidification rotor which is then supplied to the indoors.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a flow diagram of a conventional gas turbine co-generation system.

FIG. 2 is a schematic view of a conventional dehumidification air-conditioner.

FIG. 3 is a perspective view of a dehumidification rotor used in a conventional dehumidification air-conditioner, in a rotary type sensible-type heat exchange element, and in an embodiment of the present invention.

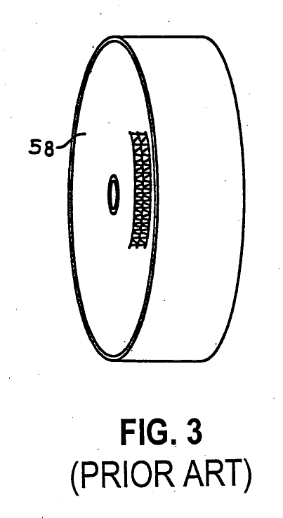

FIG. 4 is a schematic view of the first embodiment of a gas turbine co-generation system.

FIG. 5 is a perspective view of the desiccant air-conditioning unit used for the gas turbine cogeneration system.

FIG. 6 is a cross sectional view of the honeycomb object used for the gas turbine co-generation system.

FIG. 7 is a flow diagram of the first embodiment of an internal combustion engine co-generation system.

FIG. 8 is a flow diagram of the second embodiment of the internal combustion engine co-generation system.

FIG. 9 is the flow diagram of the third embodiment of the internal combustion engine co-generation system.

FIG. 10 is a schematic view of the first embodiment of a dehumidification air-conditioner.

FIG. 11 is a partial perspective view of a perpendicular intersected type sensible-heat exchange element used for the dehumidification air-conditioner.

FIG. 12 is a schematic view of the second embodiment dehumidification air-conditioner.

FIG. 13 is a schematic view of the third embodiment of the dehumidification air-conditioner.

FIG. 14 is a schematic view of the fourth embodiment of the dehumidification air-conditioner.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

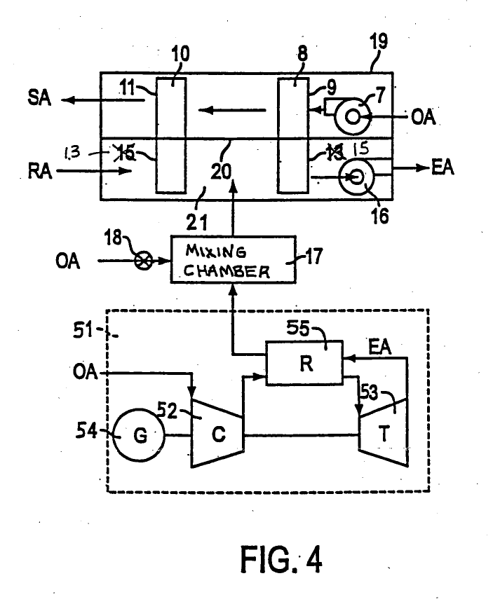

The first embodiment of the gas turbine co-generation system is explained in detail in the flow drawing of FIG. 4.

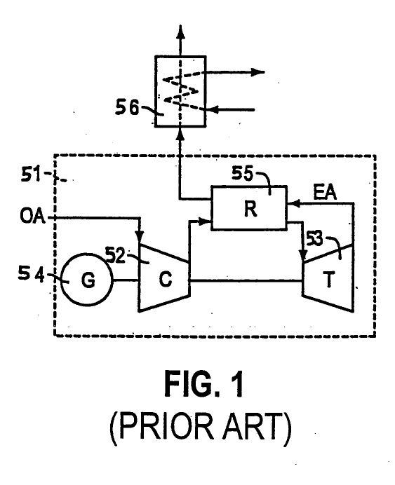

The conventional gas turbine co-generation system shown in FIG. 1 and the first embodiment of the gas turbine co-generation system shown in this FIG. 4 have common equipment including gas turbine unit 51, compressor 52, turbine 53, dynamo 54, and heat exchanger 55. Explanations of equipment that overlap will be omitted to avoid redundancy.

A mixing chamber 17 mixes the open air OA and the exhaust gas of the gas turbine unit 51, and has a valve 18 which adjusts the amount of the open air OA introduced into the mixing chamber 17. The exit of the mixing chamber 17 is open for free passage to a desiccant air-conditioning unit 19. The details of the free passage are described below.

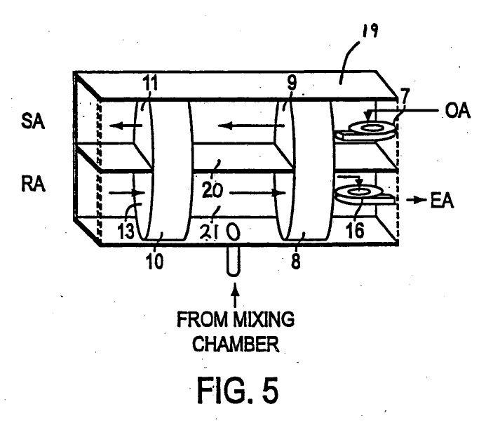

FIG. 5 shows a desiccant air-conditioning unit with a humidity adsorption rotor 8. The humidity adsorption rotor is formed, for example, in the shape of a honeycomb with ceramic fibers having compounds such as silica gel therein. A rotation drive of the humidity adsorption rotor 8 is continuously rotated by a motor (not shown).

Moreover, the humidity adsorption rotor 8 is divided into an adsorption zone 9 and a desorption zone 15 by a partition board 20. The rotary type sensible-heat exchange element 10 is formed from aluminum foil into the shape of honeycombs into the shape of a disk. A rotary drive of the rotary type sensible-heat exchange element 10 is continuously rotated by a motor (not shown).

Moreover, the rotary type sensible-heat exchange element 10 is divided into a cooling zone 11 and a heating zone 13 by the partition board 20. The air which passes through the cooling zone 11 is supplied to the indoors as product air SA after air-conditioning. Also, air from the interior of a room RA passes through the heating zone 13, and is emitted to the outdoors.

A blower 7 feeds the open air OA to the adsorption zone 9 side of the desiccant air-conditioning unit 19, and blower 16, which inhales air from the desorption zone 15 of the desiccant air-conditioning unit 19, emits the inhaled air to the atmosphere (outdoors).

Moreover, the exit of the mixing chamber 17 as shown in FIG. 4, is open for free passage to a chamber 21 surrounded by the partition board 20 of the desiccant air-conditioning unit 19, by the humidity adsorption rotor 8, and by the rotary type sensible-heat exchange element 10.

The first embodiment of the gas turbine co-generation system of the present invention is constituted as above-mentioned with operation of the gas turbine co-generation system explained below. First, summer operation of the gas turbine co-generation system is explained. When the gas turbine unit 51, as shown in FIG. 4, is operated, the atmosphere (outdoors air) is compressed by the compressor 52, heated by the heat exchanger 55, and goes into turbine 53.

The fuel is mixed in the turbine 53 and is burned, thereby causing the turbine 53 to rotate. The heat exchanger 55 removes heat from the hot exhaust gas, which comes from the turbine 53. The exhaust gas is reduced from a temperature of several 100° C. to about 250° C. Exhaust gas then goes into the mixing chamber 17, and is mixed with the open air OA, where the temperature decreases to about 200° C., and it then goes into a chamber 21. From the quantity of the air supplied to the chamber 21 from the mixing chamber 17 (the air which the blower 16 inhales), a negative pressure is set up in chamber 21 thereby causing indoor air to pass through the heating zone 13 of the rotary type sensible-heat exchange element 10 and enter into the chamber 21. The inside of the mixing chamber 17 also develops a negative pressure due to the negative pressure in chamber 21. By adjusting the degree of opening of valve 18, the mixture rate of the open air OA mixed by the mixing chamber 17 can be adjusted. Indoor air which is low temperature moves into and passes through the heating zone 13 of the rotary type sensible-heat exchange element 10, thereby reducing the temperature of the rotary type sensible-heat exchange element 10. That is, indoor low-temperature air, which cools the rotary type sensible-heat exchange element 10, increases in temperature and the air, which passed through the heating zone 13, enters in the chamber 21. The exhaust gas from the gas turbine unit 51 which reaches about 200° C. through the mixing chamber 17, goes into a chamber 21, is mixed with the air which passed through the heating zone 13, and is reduced to a temperature of about 140° C.

If the humidity adsorption rotor 8 is rotated at ⅓ rotations per minute, then the air which is about 140° C. carries out the desorption of the moisture which was adsorbed by the humidity adsorption rotor 8 and which passes through the desorption zone 15. The air which passed through the desorption zone 15 turns into high-humidity air, and is emitted to the atmosphere by the blower 16.

The desorption of the humidity is carried out in this way, wherein the captured moisture from the adsorption zone 9 is carried out (desorbed) in the desorption zone 15. A portion of the humidity adsorption rotor 8 rotates back to the adsorption zone 9, and performs humidity adsorption of the open air OA. Forced by the blower 7 of the desiccant air-conditioning unit 19, the open air OA passes through the adsorption zone 9 of the humidity adsorption rotor 8, and turns into dry air. At this time, temperature increases somewhat due to adsorption heat.

The dry air which rose in temperature passes through the cooling zone 11 of the rotary type sensible-heat exchange element 10, gives off heat to the rotary type sensible-heat exchange element 10, thereby reducing the dry air temperature. The dry air SA, which is reduced in temperature, is supplied indoors. Thus, the air dried in the desiccant air-conditioning unit 19 is supplied indoors, and the interior of a room is provided with comfortable air conditions.

The energy consumed for the latent heat load (the energy required to decrease the indoor humidity) of an air conditioner can be decreased. For summer when humidity and temperature are high, this latent heat load may be about 60% of the load energies of an air-conditioner. By mitigating the latent heat load of an air-conditioner, the consumption energy of an air-conditioner can be substantially reduced.

For winter, the rotary type sensible-heat exchange element 10, stops rotation and rotation of the humidity adsorption rotor 8 is set at about 20-30 rotations per minute. Then, the 140° C. air of the mixing chamber 17 passes through the desorption zone 15, and raises the temperature of the humidity adsorption rotor 8. At this time, since the number of rotations of the humidity adsorption rotor 8 is high, the desorption of the humidity is increased and adsorption is not carried out for the humidity adsorption rotor 8, therefore desorption is also not carried out. Since the open air OA that passed through the adsorption zone 9 has the high temperature of the humidity adsorption rotor 8, the open air OA temperature increases. However, temperature increases without adsorption of humidity, since desorption can only be carried out by the humidity adsorption rotor 8 in the desorption zone 15 after adsorption. Since the rotary type sensible-heat exchange element 10 is not rotating, the rotary type sensible-heat exchange element 10 does not produce a heat exchange action. Therefore, while air temperature is high, air is supplied indoors, and a heating action is demonstrated. Thus, a desiccant air-conditioning unit demonstrates an air-conditioning (heating) action in winter.

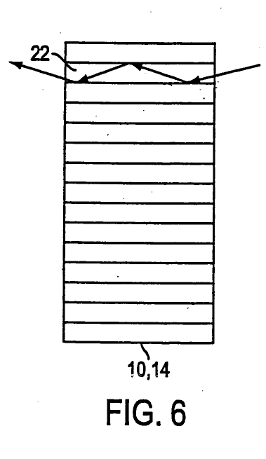

In addition, for the exhaust gas from the gas turbine unit 51 to go into a chamber 21 through the mixing chamber 17, the loud exhaust sound of the gas turbine unit 51 goes into chamber 21. The exhaust sound passes the rotary type sensible-heat exchange element 10, and enters the interior of the desiccant air-conditioning unit, and is emitted to the exterior of the unit through the humidity adsorption rotor 8. Both the rotary type sensible-heat exchange element 10 and the humidity adsorption rotor 8 are honeycomb-like having small free passages, wherein many holes 22 are formed as shown in a cross-section view in FIG. 6. The loud exhaust sound of the gas turbine unit 51, which is shown in FIG. 6, in the free passage moving toward the exterior, and colliding with the surface of a wall of the hole 22. Attenuation occurs with the degree of collisions, and the loud exhaust sound is reduced until finally it becomes a small sound as it emerges from the passage to the exterior.

Moreover, since loud sound waves generally move in straight lines, the effect of the humidity adsorption rotor 8, which is honeycomb-like having small free passages, on the loud exhaust sound is strong attenuation. Furthermore, the energy of the high frequency sound wave is attenuated by the desorption of the humidity. Therefore, the rate of attenuation of the unpleasant loud sounding noise is high.

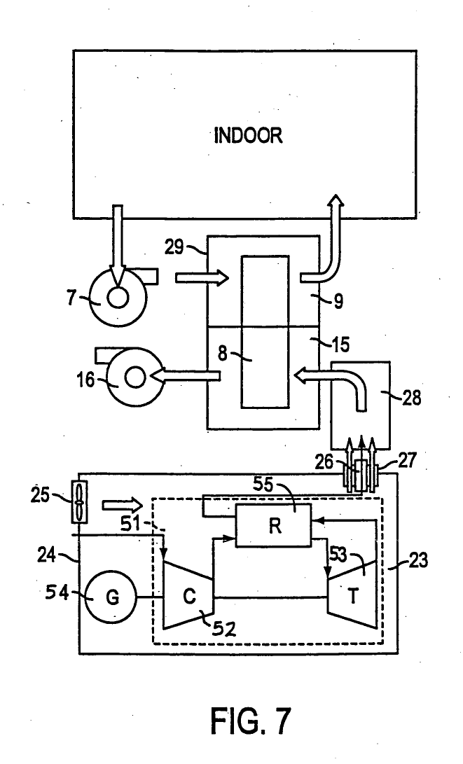

Next, the first embodiment of the internal combustion engine co-generation system of the present invention is explained in detail with reference to FIG. 7.

The power generation part 23 includes a casing 24 surrounding the entirety of the power generation part 23, a dynamo 54, a gas turbine 53, a cooling blower 25, etc. The dynamo 54 is connected with the gas turbine 53, and generates electricity by rotation of the gas turbine 53. The gas turbine unit 51 includes a compressor 52, the turbine 53, and a heat exchanger 55, wherein the air, which is compressed by the compressor 52 is heated by the heat exchanger 55, and goes into the turbine 53.

Fuel, which is mixed at high-pressure with hot air, burns at the entrance of the turbine 53, causing a driving force on the turbine 53. The hot exhaust gas, which comes out of the turbine 53 through the heat exchanger 55, preheats the air, which comes out of the compressor 52. The hot exhaust gas is then discharged from the exhaust gas outlet 26. The temperature of the exhaust gas at this point is about 280° C.

Moreover, the open air OA is taken in by the cooling blower 25 in casing 24, and the gas turbine 53 and the dynamo 54 are cooled by the open air OA. About 30° C. of temperature increase occurs to the temperature of the air that cooled the gas turbine 53 and the dynamo 54. This air is discharged from the cooling air outlet 27. Since the temperature of the exhaust gas is about 280° C., the temperature of the exhaust gas outlet 26 also rises to 200° C. or more.

The exhaust gas outlet 26 is surrounded by the cooling air outlet 27 for safety. That is, the exhaust gas outlet 26 and the cooling air outlet 27 are formed in the same axial shape. A mixing chamber 28 mixes the air from the exhaust gas in the cooling air outlet 27 and the exhaust gas outlet 26. The exit of this mixing chamber 28 is connected to the reactivation zone 15 of the dehumidification part 29. Honeycomb-like dehumidification rotor 8, where humidity adsorbents such as silica gel are supported, is established in the dehumidification part 29. The dehumidification part 29 is divided into the adsorption zone 9 and the reactivation zone 15.

Moreover, the rotation drive of the dehumidification rotor 8 is rotated by the motor (not shown). The suction side of the blower 16 is connected with the reactivation zone 15 so that the blower 16 may inhale the air of the reactivation zone 15 of the dehumidification part 29.

A blower 7 inhales indoor air and sends it to the adsorption zone 9 of the dehumidification part 29. The first embodiment of the internal combustion engine co-generation system of the present invention includes of the above composition. The operation is explained below.

Fuel is first sent to a gas turbine 53, and the gas turbine 53 is started. A dynamo 54 starts power generation through the gas turbine 53. The dynamo 54 generates electric power corresponding to about 28% of the energy that is burned in fuel. Heat exchange is carried out by the heat exchanger 55 with the air which comes out of the compressor 52. After the heat exchange, the temperature of the hot air which exits the turbine 53 coming from the exhaust gas outlet 26 of the power generation part 23 decreases to about 280° C. The exhaust gas, which comes from the exhaust gas outlet 26, has about 57% of the energy of the fuel, which was burned. Moreover, the open air OA is sent by the cooling blower 25 in casing 24 to the gas turbine 53 and to the dynamo 54, which are both cooled by the air.

The open air OA takes the heat of the gas turbine 53 and the dynamo 54, and the open air OA temperature increases by about 30° C. The open air OA is then discharged from the cooling air outlet 27 having about 10% of the energy of the fuel, which was burned. The exhaust gas, which comes out from the exhaust gas outlet 26, and the air discharged from the cooling air outlet 27, are mixed in mixing chamber 28 and turned into air with a temperature of about 140° C., which is then blown by blower 16 into the reactivation zone 15 of the dehumidification part 29.

With the air about 140° C. in temperature, the portion of the humidification rotor 8 containing captured moisture to which the desorption was carried out, rotates back to the adsorption zone 9, and dehumidifies indoor air. Consequently, the energy of the exhaust gases from the outlets 26 and 27 representing 57% and 10%, respectively, of the energy of the fuel which is burned and which did not contribute to electric power generation, is used for the desorption of the dehumidification rotor 8.

The energy, during high temperatures and 60% of high humidities, will be mostly used for indoor dehumidification of, for example, a hospital or a place of business, which installs the gas turbine co-generation system. A freezer, for example, consumes 60% of its energy from latent heat load in reducing the temperature from 32° C. to 25° C. The latent heat load is the energy to dehumidify the freezer.

That is, although indoor air is dehumidified when the moisture in indoor air condenses on the evaporator of an air conditioner during air conditioning, when water condenses, latent heat load occurs. Therefore, if indoor air is dehumidified by the dehumidification part 29, the load of an air conditioner will be reduced to only the sensible-heat load, and the energy consumption of an air conditioner will be reduced below half.

While 72% of the energy did not contribute to power generation, 67% is used for dehumidification and decreases the load of an air conditioner. Since the remaining heat can be used, in particular in summer effectively, the energy-saving effect is very substantial.

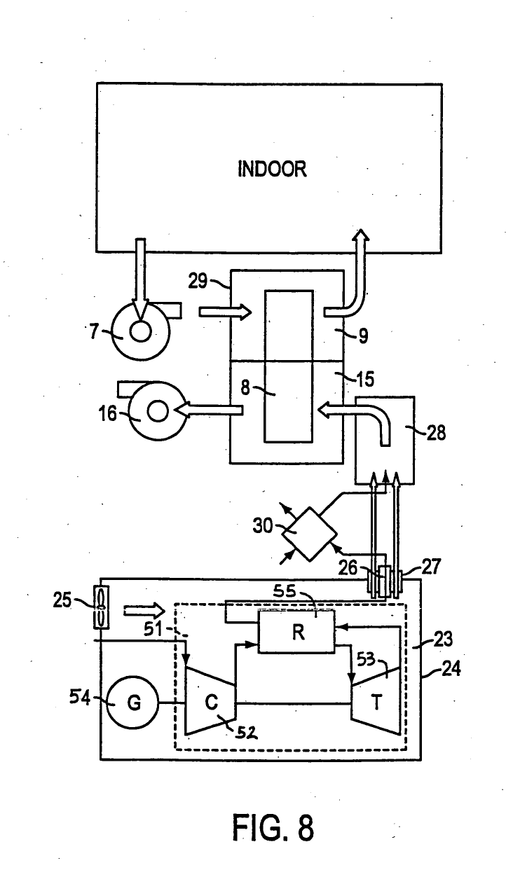

A gas turbine using natural gas or liquefied petroleum gas has few toxic substances contained in the exhaust gas, such as hydrocarbon and carbon monoxide, and can satisfactorily use an exhaust gas for reactivation of the direct dehumidification rotor 8. However, when indoor air requires exceptional purity, a second embodiment of the internal combustion engine co-generation system explained below can be used. FIG. 8 is a flow drawing of this second embodiment which has equipment in common with the first embodiment of FIG. 7, namely, the power generation part 23, the casing 24, the dynamo 54, the gas turbine 53, the cooling blower 25, the exhaust gas outlet 26, the cooling air outlet 27, the mixing chamber 28, the dehumidification part 29, the reactivation zone 15, the dehumidification rotor 8, the adsorption zone 9, and blowers 7 and 16. The explanation of the second embodiment of the internal combustion engine co-generation system, which follows, omits overlap in order to avoid redundancy.

In the second embodiment of the internal combustion engine co-generation system a heat exchanger 30 is provided which performs heat exchange with the exhaust gas and the atmosphere which comes out of the exhaust gas outlet 26. The heat exchanger leads from the exhaust gas outlet 26 to the mixing chamber 28, therein passing high temperature air.

A parallel opposite flow type heat exchanger is mutually suitable for a perpendicular type heat exchanger having two air passages, wherein the two air passages, which are mutually independent, have thermal conductivity as the heat exchanger 30 and have mutually perpendicular intersections. Generally the heat exchange efficiency of such a heat exchanger is between 60%-70%, and therefore between 60% and 70% of the 57% of the energy which remains as heat from exhaust outlet 26 and 10% of the energy, which remains as heat from the cooling outlet 27 can be used for dehumidification.

A perpendicular intersected type heat exchanger is formed to return indoors the air, which comes out of the dehumidification part 29 as in the above-mentioned first and second embodiments of the internal combustion engine co-generation system. In an internal combustion engine co-generation system, where air passes the dehumidification rotor 8, so that the dehumidification rotor 8 may adsorb the humidity in the air and may emit adsorption heat, the temperature of the dry air, which is supplied from the dehumidification part 29, is high.

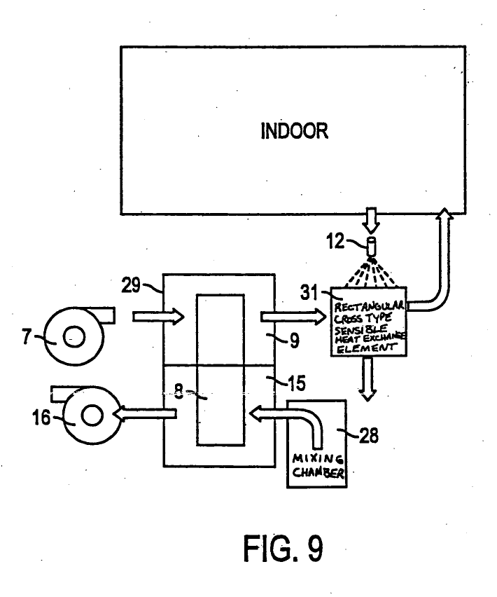

A third embodiment cooling the dry air supplied from the dehumidification part 29, and supplying the dry air indoors is explained below. FIG. 9 expresses only the principal part of the embodiment.

This third embodiment of the internal combustion engine co-generation system is common relative to the first embodiment of FIG. 7, including the power generation part 23, the casing 24, the dynamo 54, the gas turbine 53, the cooling blower 25, the exhaust gas outlet 26, the cooling air outlet 27, the mixing chamber 28, the dehumidification part 29, the reactivation zone 15, dehumidification rotor 8, the adsorption zone 9, and blowers 7 and 16.

The third embodiment is also common with respect to the heat exchanger 30, but omits illustration of the power generation part 23, the casing 24, the dynamo 54, the gas turbine 53, the cooling blower 25, the exhaust gas outlet 26, the cooling air outlet 27, and the heat exchanger 30. Further, to avoid redundancy, explanations are omitted with respect to the third embodiment when they overlap with the second embodiment of the internal combustion engine co-generation system of FIG. 8. With respect to the first and second embodiments of the internal combustion engine co-generation system of FIGS. 7 and 8, respectively, the third embodiment of the internal combustion engine co-generation system of FIG. 9 provides a suction side of the blower 7, which is opened wide to the atmosphere to allow indoor air free passage.

In FIG. 9, in one passage of the perpendicular intersected type sensible-heat exchange element 31 the air from the interior of the room passes, and in another passage through another side the air from the adsorption zone 9 of the dehumidification part 29 passes. Moreover, the exit of one passage is wide opened to the atmosphere, and the exit of the other passage of another side is open for free passage to the interior of the room.

The water spray 12 sprays water on the air included in one passage of the perpendicular intersected type sensible-heat exchange element 31 from the interior of the room. The air temperature of the air which is included in one passage of the perpendicularly intersected type sensible-heat exchange element 31 from the interior of a room which has water sprayed by the water spray 12, decreases due to the evaporation heat of water.

Although in the one passage the air temperature is increasing when passing the perpendicular intersected type sensible-heat exchange element 31 because of heat exchange, the air from another passage is cooled, and the dry air from the adsorption zone 9 of the dehumidification part 29 turns into low-temperature dry air, which is supplied indoors. In this third embodiment of the internal combustion engine co-generation system, indoor air is emitted to the atmosphere from one passage of the perpendicularly intersected type sensible-heat exchange element 31, and the atmosphere is supplied indoors through the other passage of another side by a blower 7, the adsorption zone 9, and the perpendicular intersected type sensible-heat exchange element 31. Therefore, fresh air is always supplied indoors. Although the first, second and third embodiments show examples which used a gas turbine as an internal combustion engine, a reciprocating engine which uses natural gas, liquefied petroleum gas, etc. as fuel can also be completely effective.

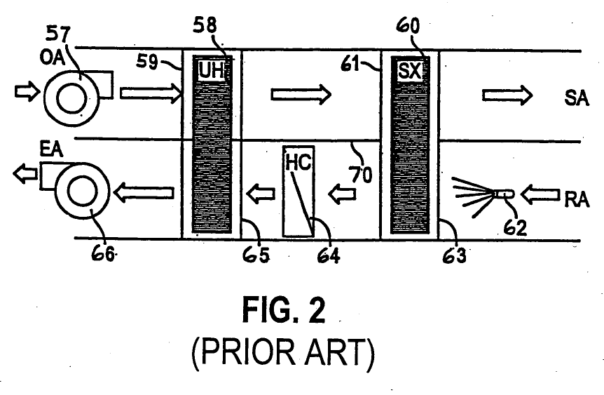

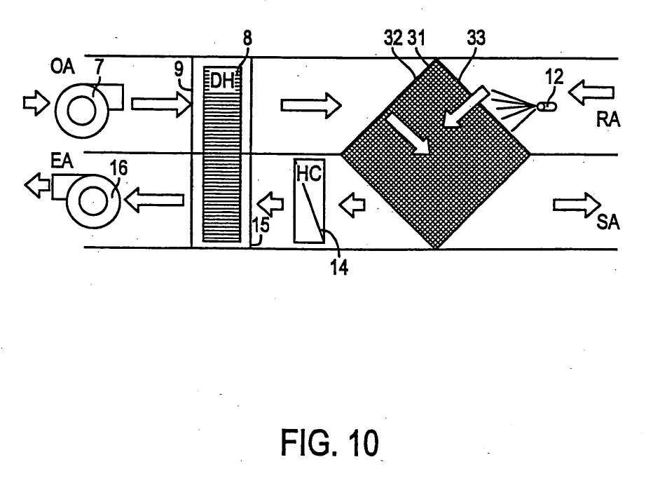

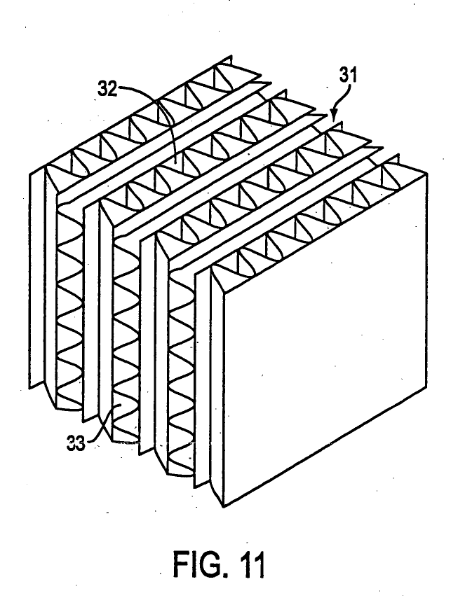

Hereafter, the first embodiment of the dehumidification air-conditioner of the present invention is explained in detail using FIG. 10 and FIG. 11. FIG. 2 shows the conventional dehumidification air-conditioner having the blower 7, the dehumidification rotor 8, the adsorption zone 9, the spray 12, the heater 14, the desorption zone 15, and the blower 16. The explanations that overlap are omitted to avoid redundancy.

The perpendicular intersected type sensible-heat exchange element 31 includes a plurality of straight sheets with wavelike sheets sandwiched therebetween as shown in a FIG. 11. Laminating is carried out so that the directions of a wave may differ by layers. The perpendicular intersected type sensible-heat exchange element 31 has a 1st passage 32 and a 2nd passage 33 which mutually intersect perpendicularly, and the sensible-heat exchange is performed by this intersection between each passage. Moreover, the gases, which pass through these two passages, are not mixed.

The air of the 1st passage 32 of the perpendicular intersected type sensible-heat exchange element 31 is open for free passage from the adsorption zone 9 of the dehumidification rotor 8. The air emerges from the 1st passage 32 of the perpendicular intersected type sensible-heat exchange element 31 and is supplied as product air SA.

A spray 12 is formed so that water may be sprayed on the 2nd passage 33 of the perpendicular intersected type sensible-heat exchange element 31. The exit of the 2nd passage 33 of the perpendicular intersected type sensible-heat exchange element 31 is open for free passage at the heater 14. The exit of a heater 14 is open for free passage to the desorption zone 15 of the dehumidification rotor 8, and the exit of the desorption zone 15 is open for free passage to the suction mouth of the blower 16.

The first embodiment of the dehumidification air-conditioner of the present invention is constituted as above-mentioned, and the operation is explained below. The blower 7 and the blower 16 are operated first, and water is supplied to the spray 12. While rotating the dehumidification rotor 8, the heater 14 is energized, or steam is sent and the heater 14 is changed into an exothermic state. The blower 7 blows open air OA to the adsorption zone 9 of the dehumidification rotor 8, wherein the open air OA turns into dry air, and the temperature of the open air OA increases with adsorption heat.

The dry air, which rose in temperature, passes through the 1st passage 32 of the perpendicular intersected type sensible-heat exchange element 31. The dry air which comes from the 1st passage 32 of the perpendicular intersected type sensible-heat exchange element 31 carries out heat exchange with the air which passes through the 2nd passage 33, and the dry air temperature is reduced. The cool dry air is supplied indoors as product air SA. Indoor air RA is inhaled by the blower 16 and first passes through the spray 12. Since indoor air is generally about between 60%-70% of relative humidity, the water supplied by the spray 12 is evaporated and indoor air RA is cooled.

The indoor air RA cooled by the spray 12 passes through the 2nd passage 33 of the perpendicular intersected type sensible-heat exchange element 31. The amount of water sprayed by the spray 12 is more than the amount of evaporation. Waterdrops enter into the 2nd passage 33 with the air due to the amount of water sprayed.

The waterdrops with small diameters float in air, and enter into the 2nd passage 33, while the waterdrops with big diameters fall into the 2nd passage 33. The water drops with the small diameters, which float in air, will be evaporated if the temperature in the 2nd passage 33 rises by heat exchange.

Moreover, the big water drops, which fell into the 2nd passage 33, wet the inner wall of the 2nd passage 33, and form a thin layer of water. The thin layer of water is evaporated with the rise of the temperature of the inner wall of the 2nd passage 33 by heat exchange. Thus, due to the evaporation heat of water, the temperature in the 2nd passage 33 of the perpendicular intersected type sensible-heat exchange element 31 is reduced.

Since heat exchange is performed between the 2nd passage 33 and the 1st passage 32, the temperature of the 1st passage 32 is reduced. The air, which passed through the 2nd passage 33 of the perpendicular intersected type sensible-heat exchange element 31, goes into the heater 14.

The heater 14 is a radiator, an electric heater or a gas burner, which burns inflammable gas, such as a natural gas and a liquefied petroleum gas. The heater 14 may be a heating means, such as a means like the mixed gas of the high temperature exhaust gas from other combustion apparatus or high temperature exhaust gas and air. The air which is heated at the heater 14 and which passes along the desorption zone 15 of the dehumidification rotor 8, carries out the desorption of the moisture. The moisture having been adsorbed by the moisture absorption agent of the dehumidification rotor 8 is emitted to the atmosphere by the blower 16 as exhaust gas EA.

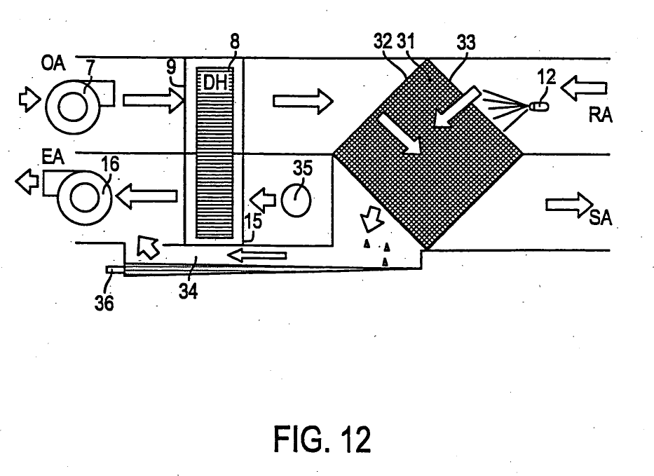

Thus, the open air OA becomes dry and cold, and is supplied indoors, while the return air RA from the interior of the room becomes high in humidity and hot air, which is emitted to the atmosphere. FIG. 12 shows the second embodiment of the dehumidification air-conditioner of the present invention, and is explained in detail below.

The blower 7, the dehumidification rotor 8, the adsorption zone 9, the spray 12, the desorption zone 15, the blower 16, the perpendicular intersected type sensible-heat exchange element 31, the 1st passage 32, and the 2nd passage 33, have the same explanation as the above-mentioned first embodiment of the dehumidification air-conditioning, and overlap is omitted.

The exhaust passage 34 is formed from the exit of the 2nd passage 33 of the perpendicular intersected type sensible-heat exchange element 31 to the suction mouth of the blower 16.

Moreover, the high temperature exhaust gas free passage mouth 35 is formed which puts exhaust gas from, for example, a gas turbine dynamo, into the open free passage in the desorption zone 15. Furthermore, an inclination is provided at the bottom of the exhaust passage 34, and a drainpipe 36 is formed in the lowest portion.

The dehumidification air-conditioner of the second embodiment of the present invention is constituted as above-mentioned, and the operation is explained below.

The blowers 7 and 16 are first energized, and water is supplied to the spray 12. While rotating the dehumidification rotor 8, the hot exhaust gas, which is produced, for example, from a gas turbine dynamo etc. as shown in the high temperature exhaust gas free passage mouth 35 in FIG. 4, is supplied to the exhaust gas free passage mouth 35. While the open air OA turns into dry air after being sent to the adsorption zone 9 of the dehumidification rotor 8 by the blower 7, the open air OA temperature increases with adsorption heat.

The dry air, which rose in temperature, passes through the 1st passage 32 of the perpendicular intersected type sensible-heat exchange element 31. The dry, air which comes from of the 1st passage 32 of the perpendicular intersected type sensible-heat exchange element 31, carries out heat exchange with the air which passes through the 2nd passage 33. The temperature of the dry air is reduced and the cool, dry air is supplied indoors as supply air SA. Indoor air RA is inhaled by the blower 16 and first passes through the spray 12. Since indoor air is generally about between 60%-70% of relative humidity, the water supplied by the spray 12 is evaporated and the air RA is cooled.

The air RA cooled by the spray 12 passes through the 2nd passage 33 of the perpendicular intersected type sensible-heat exchange element 31. The amount of water sprayed by the spray 12 is more than the amount of evaporation. Waterdrops enter into the 2nd passage 33 with the air due to the amount of water sprayed.

The waterdrops with small diameters float in air, and enter into the 2nd passage 33, while the waterdrops with big diameters fall into the 2nd passage 33. The waterdrops with the small diameters, which float in air, will be evaporated if the temperature in the 2nd passage 33 rises by heat exchange.

Moreover, the big water drops, which fell into the 2nd passage 33, wet the inner wall of the 2nd passage 33, and form a thin layer of water. The thin layer of water is evaporated with the rise of the temperature of the inner wall of the 2nd passage 33 by heat exchange.

By the evaporation heat of this water, the temperature in the 2nd passage 33 of the perpendicular intersected type sensible-heat exchange element 31 is reduced. Since heat exchange is performed between the 2nd passage 33 and the 1st passage 32, the temperature of the 1st passage 32 is reduced. The air, which passed through the 2nd passage 33 of the perpendicular intersected type sensible-heat exchange element 31, is emitted to the atmosphere by the blower 16 through the exhaust passage 34.

Hot exhaust gas which goes into the high temperature exhaust gas free passage mouth 35 carries out the desorption of the humidity by passing through the desorption zone 15 after adsorption by the dehumidification rotor 8. The air which passed through the desorption zone 15 becomes high-humidity air, while the air RA from the exhaust passage 34 becomes exhaust gas EA and is emitted to the atmosphere by the blower 16.

The waterdrops dropped from the perpendicular intersected type sensible-heat exchange element 31 collect on the bottom of the exhaust passage 34. Since the bottom of this exhaust passage 34 inclines, the dropped water moves to the lowest inclination and is drawn from the drainpipe 36 to outside.

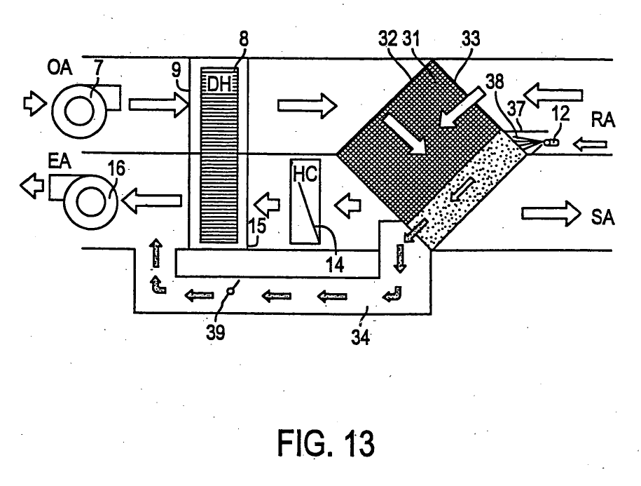

The third embodiment of the dehumidification air-conditioner shown in FIG. 13 is explained in detail below.

The blower 7, the dehumidification rotor 8, the adsorption zone 9, the spray 12, the desorption zone 15, the blower 16, the perpendicular intersected type sensible-heat exchange element 31, the 1st passage 32, and the 2nd passage 33 are the same as that of the first above-mentioned embodiment of the dehumidification air-conditioner. The exhaust passage 34 is the same as explained in the second above-mentioned embodiment of the dehumidification air-conditioner, and overlap is omitted. In FIG. 13, the partition board 37 divides a part of the 2nd passage 33 entrance of the perpendicular intersected type sensible-heat exchange element 31.

The spray 12 is formed in one side of the divided 2nd passage 33 entrance, and the cooling passage 38 is constituted. The cooling passage 38 is provided such that the amount of spraying by the spray 12 produces a state where the particles of water float in the air whose relative humidity is 100%. The exhaust passage 34 is between the exit of the cooling passage 38 and the suction side of the blower 16.

A valve 39 is formed which adjusts the quantity of the air which passes the exhaust passage 34 along an opening and a closing in the middle of the exhaust passage 34. The third embodiment of the dehumidification air-conditioner of the present invention is constituted as above-mentioned, and the operation is explain below.

The blower 7 and the blower 16 are started. Next, the heater 14 such as a gas burner is lit, and water is sent to the spray 12. Then, the open air OA is inhaled by the blower 7, and is moved by the blower 7 into the adsorption zone 9 of the dehumidification rotor 8. While the dehumidification rotor 8 is adsorbing humidity in the open air OA, which then turns into dry air, temperature of the dry air increases with adsorption heat.

The dry air, which rose in temperature, goes into the 1st passage 32 of the perpendicular intersected type sensible-heat exchange element 31. Dry air gives off the sensible heat to the perpendicular intersected type sensible-heat exchange element 31, and dry air temperature is reduced. That is, dry air temperature decreases, and the dry air which came out of the 1st passage 32 of the perpendicular intersected type sensible-heat exchange element 31 turns into comfortable supply air SA by the evaporation heat of the water sprayed by the spray 12. The supply air SA is supplied indoors thereafter.

Indoor air RA moves into the 2nd passage 33 of the perpendicular intersected type sensible-heat exchange element 31 by suction of a blower 16. Since the inside of the exhaust passage 34 is also a negative pressure at this time, indoor air RA also moves into the cooling passage 38. While the air in the cooling passage 38 is humidified by the spray 12 causing air temperature to decrease, the particles of water are floating.

Moreover, the inside of the cooling passage 38 is wet with water. While passing through the cooling passage 38, the water which wets other particles of water and the inside of the cooling passage 38 is evaporated by the air which passes through the 1st passage 32 of the perpendicular intersected type sensible-heat exchange element 31. This water in the cooling passage 38 takes evaporation heat and moves into the exhaust passage 34.

Since only sensible-heat exchange is performed between the 1st passage 32 and the 2nd passage 33 of the perpendicular intersected type sensible-heat exchange element 31, no mixture of gases from the two respective passages occurs. Specifically, the air in the 1st passage 32 and the air in the cooling passage 38 are not mixed. Therefore, the air, which passes through the 1st passage 32 of the perpendicular intersected type sensible-heat exchange element 31, is cooled, without being humidified.

Heat exchange is carried out with the dry air which rose in temperature due to the increase in temperature of the dehumidification rotor 8 from adsorption heat. Dry air temperature further increases at the heater 14 and the air included in the 2nd passage 33 of the perpendicular intersected type sensible-heat exchange element 31 becomes high temperature air.

This high temperature air passes through the desorption zone 15 of the dehumidification rotor 8, and carries out the desorption of the moisture which the dehumidification rotor 8 captured. The hot and highly humid air, which comes from the desorption zone 15 of the dehumidification rotor 8 passes the blower 16, and becomes exhaust gas EA, which is emitted to the atmosphere.

Moreover, with the hot and highly humid air which comes from the desorption zone 15 of the dehumidification rotor 8, the air which passed through the exhaust passage 34 also becomes exhaust gas EA, and is emitted to the atmosphere by the blower 16. By adjusting a valve 39 and/or regulating the amount of spray from the spray 12, the quantity of the air, which flows in the exhaust passage 34, can be adjusted, and the temperature of supply air SA can be controlled.

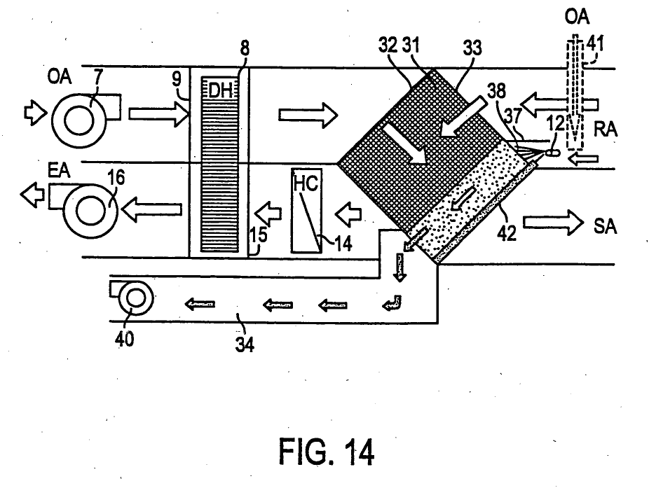

FIG. 14 is a schematic view showing the fourth embodiment of the dehumidification air-conditioner. As compared with the third embodiment shown in FIG. 13, the fourth embodiment of FIG. 14 shows another blower 40 configured to be used exclusively for the removal the air from inside the exhaust passage 34. The configuration of the open air introduction pipe 41 is also different. Moreover, the humidification element 42 which is attached in the 1st passage 32 exit of the perpendicular intersected type sensible-heat exchange element 31, and the removal of valve 39 are different. The quantity of the air, which flows in the exhaust passage 34, can be controlled by controlling the blower 40, which is configured to be used exclusively for the removal of the air from inside the exhaust passage 34. Moreover, FIG. 14 shows the open air introduction pipe 41 which introduces the direct open air OA into the cooling passage 38. The cooling passage 38 is a portion of the 2nd passage and is divided by the partition board 37.

When there is a smaller quantity of the return air RA from the interior of the room than the quantity of the product air SA, for example, when a ventilation fan etc. is installed indoors (not shown) and is supplied to the interior of a room, it is advantageous for the open air introduction pipe 41 to supply the direct open air OA to the cooling passage 38. Also, when a large generation source of humidity is indoors, and the humidity of the return air RA from the interior of a room is higher than the open air OA, it is advantageous for the direct open air OA to be supplied to the cooling passage 38 from the open air introduction pipe 41, because the cooling effect in the cooling passage 38 is higher.

Furthermore, in FIG. 14, the cooling passage 38 has a high water retention capability. Also, the humidification element 42 has breathability from, for example, a nonwoven fabric. The tip of the humidification element 42 is projected in the cooling passage 38, and water is supplied with the spraying water from the spray 12.

Humidification cooling of the air which comes from the 1st passage 32 of the perpendicular intersected type sensible-heat exchange element 31 is carried out by this, and temperature further decreases due to the humidification cooling. That is, although humidity increases somewhat in the supply air SA, temperature of the supply air falls further. This embodiment is suitable when the humidity of the open air OA is low and the temperature of the open air OA is high. Although this embodiment shows the example of a nonwoven fabric as a humidification element 42, the nonwoven fabric can be in the form of a honeycomb, coarse felt, or a large sponge as long as it has the characteristics of hydrophilicity and breathability.

In each above embodiment, although the perpendicular intersected type sensible-heat exchange element 31 was used as a static type heat exchange element, a heat exchange element which uses an opposite style type heat exchange element and a heat pipe also can be used.

With the gas turbine co-generation system of the first embodiment of the present invention as constituted like the above, the loud and unpleasant exhaust sound of the gas turbine unit 51 can be sharply decreased.

Furthermore, since the attenuation mechanism of the exhaust sound is the humidity adsorption rotor. The humidity adsorption rotor not only attenuates exhaust sound, but can also dehumidify using the remaining heat from the exhaust gas of the gas turbine co-generation system, thereby offsetting the large summer power consumption peak.

Generally, the summer power consumption peak is large because of humidity and high temperatures and the resulting electric power consumed by air conditioners. Therefore, large power supply equipment infrastructure to handle the summer peak consumption is required. However, by constructing the gas turbine co-generation system to work coincident with the power consumption, it is possible to decrease the power consumption of an air conditioner. The gas turbine co-generation system not only generates electricity, but also can reduce the peak summer power consumption by providing both power generation and demand energy saving. Since the present invention can use the remaining heat effectively for peak summer electricity demand, the plant-and-equipment investment is cost effective.

Moreover, since it is constructed to let the exhaust gas of a gas turbine pass to the space inserted between the honeycomb-like heat exchange rotor and the humidity adsorption rotor, the present invention can further reduce noise. The embodiments of the internal combustion engine co-generation system can use the cooling air to cool not only waste heat but also the internal combustion engine which also emits exhaust gas, therefore a very high thermal efficiency can be expected.

Furthermore, the waste heat from an internal combustion engine of the internal combustion engine co-generation system can be used as the adsorbent/desorption heat of the dehumidification part to mitigate the load of an air conditioner at times, in particular, summer times when waste heat is abundant. Power consumption can be reduced in summer, thereby reducing the large electric power supply infrastructure.

Moreover, the embodiments of the dehumidification air-conditioner can cool and supply dry air from the dehumidification part. Therefore, it can function as an air conditioner and electric energy, which is consumed by the blower, can substantially produce comfortable air conditions in the interior of a room only by the waste heat of an internal combustion engine. Since the third embodiment of the dehumidification air-conditioner produces lower temperature by sensible-heat exchange, the humidity of supply air cannot increase and the dehumidification air-conditioner can supply highly comfortable air.

In the case of the embodiment in which the indoor air passes the static type heat exchanger, like the embodiment shown in FIGS. 12-14, even if indoor air is polluted with contaminants, such as smoke of a cigarette, indoor air cannot contact the dehumidification rotor, therefore preventing contamination of the dehumidification rotor. Further, an indoor contaminant does not mix in supply air. Moreover, the static type sensible-heat exchange element is performing both exhaust heat recovery (cooling of the supply air), and indirect evaporation cooling. Also, the equipment, which is compact, can be realized at a low cost. Since the static type sensible-heat exchange element is used as a heat exchanger, humidity cannot be carried from one gas to another while heat exchange is performed, and low humidity of supply air can be maintained.

When the humidity of the open air OA is low, humidification cooling can also be added and temperature of supply air can be further reduced. Furthermore, the cooling effect will be increased if the generation source of humidity is indoors, and the open air OA is passed to the 2nd passage of the heat exchange element when indoor air is more humid than the open air OA.

The invention has been described in detail with particular reference to preferred embodiments thereof and examples, but it will be understood that variations and modifications can be effected within the spirit and scope of the invention.

What is claimed is:

1. A gas turbine co-generation system having a gas turbine comprising;
a compression unit;
a turbine; and
a power generation unit driven by a rotation output of said turbine, exhaust air of said turbine being introduced in a chamber, the exhaust air from said chamber being passed in a sound absorbing material which is formed into a honeycomb structure, and thereafter said exhaust air being emitted to the atmosphere.

2. A gas turbine co-generation system according to claim 1, wherein the sound absorbing material is a humidity adsorbing rotor having a humidity adsorbent on the honeycomb structure.

3. A gas turbine co-generation system according to claim 2, in which adsorption and desorption of humidity are performed simultaneously while the humidity adsorbing rotor is rotating.

4. A gas turbine co-generation system according to claim 1, wherein the exhaust gas of the gas turbine passes in a space between a honeycomb-shaped heat exchanger rotor and a humidity adsorbing rotor.

5. An internal combustion engine co-generation system comprising:
an internal combustion engine;
a dynamo connected with said internal combustion engine;
a casing surrounding said internal combustion engine and the dynamo;
a blower for causing an air flow in the casing to cool the internal combustion engine and the dynamo; and
a dehumidifying unit which dries air by a humidity adsorbent and in which moisture in said humidity adsorbent is desorbed by a hot air produced by mixing, said cooling air being heated by passing through said casing and an exhaust gas of said internal combustion engine.

6. An internal combustion engine co-generation system comprising:
an internal combustion engine;
a dynamo connected with said internal combustion engine;
a casing surrounding said internal combustion engine and the dynamo;
a blower for causing an air flow in the casing to cool the internal combustion engine and the dynamo; and
a dehumidifying unit which dries air by a humidity adsorbent and in which moisture in said humidity adsorbent is desorbed by a hot air, the air being heated by heat exchange with an exhaust gas of said internal combustion engine and the cooling air heated by passing in said casing being mixed and being used for hot air for the desorption of said dehumidifying unit.

7. An internal combustion engine co-generation system according to claim 5, in which the dehumidifying part has a honeycomb rotor carrying a humidity adsorbent.

8. An internal combustion engine co-generation system according to claim 5, in which the dry air supplied from the dehumidification part is cooled and supplied to a room.

9. A dehumidifying and air-conditioning apparatus comprising:
a dehumidifier rotor by which adsorbed humidity is desorbed by a heated air; and
a heat exchange element providing heat exchange between two flow passages, the heated air dried by said dehumidifier rotor being supplied to a room through one passage of said heat exchange element, air from inside of the room being passed in another passage of said heat exchange element, and water being supplied in the another passage of said heat exchange element.

10. A dehumidifying and air-conditioning apparatus according to claim 9, in which said heat exchange element is a stationary sensible heat exchange element.

11. A dehumidifying and air-conditioning apparatus according to claim 9, in which the hot air from a source of exhaust heat is applied to a part of said dehumidifier rotor.

12. A dehumidifying and air-conditioning apparatus according to claim 9, in which the air coming from one passage of the heat exchange element is humidified.

13. A dehumidifying and air-conditioning apparatus according to claim 12, in which the air coming out from the another passage of said heat exchange element is humidified by a water-spraying nozzle which forces micro-particles of water to flow with the air in the another passage of said heat exchange element.

14. A dehumidifying and air-conditioning apparatus comprising:
a dehumidifier rotor by which adsorbed humidity is desorbed by a heated air; and
a heat exchange element providing heat exchange between two flow passages, the heated air dried by said dehumidifier rotor being supplied to a room through one passage of said heat exchange element, air from inside of the room being passed in another passage of said heat exchange element, and water being supplied in the another passage of said heat exchange element, drops of said water being added in outer air and said outer air being passed in a part of the other passage of said heat exchange element.

15. A dehumidifying and air-conditioning apparatus according to claim 14 in which the dehumidifier rotor is used as the sound absorbing honeycomb material.

16. An internal combustion engine co-generation system according to claim 5, in which:
a dehumidifying and air-conditioning apparatus is used, said apparatus comprising a dehumidifier rotor capable of desorbing the adsorbed humidity by a heated air, and a heat exchanger element which provides heat exchange between two passages, one passage of said heat exchanger passing the air dried by said dehumidifying part to supply said air to a room, the air from the room passing through another passage of said heat exchanger, and water is supplied to the other passage of said heat exchanger element, and
the dehumidifier rotor is used in the dehumidifying part.

17. An internal combustion engine co-generation system according to claim 6, in which the dehumidifying part has a honeycomb rotor carrying a humidity adsorbent.

18. An internal combustion engine co-generation system according to claim 6, in which the dry air supplied from the dehumidification part is cooled and supplied to a room.

19. A dehumidifying and air-conditioning apparatus according to claim 13, wherein the passages of the heat exchange element are isolated such that the dry air in the one passage is prevented from adsorbing moisture from the humidified air in the another passage.

20. A co-generation system comprising;
a turbine; and
a power generation unit driven by a rotation output of said turbine, exhaust air of said turbine being passed to a sound absorbing honeycomb structure, and thereafter said exhaust air being emitted to the atmosphere.

21. A co-generation system comprising:
an internal combustion engine;
a dynamo connected with said internal combustion engine;
a casing surrounding said internal combustion engine and the dynamo;
a blower producing a cooling air flow in the casing; and
a dehumidifying unit in which moisture from humidified air is transferred to hot air produced by mixing said cooling air being heated by passing through said casing and an exhaust gas of said internal combustion engine.

22. An internal combustion engine co-generation system comprising:
an internal combustion engine;
a dynamo connected with said internal combustion engine;
a casing surrounding said internal combustion engine and the dynamo;
a blower producing a cooling air flow in the casing; and
a dehumidifying unit in which moisture from humidified air is transferred to hot air, the hot air being produced by heat exchange with the cooling air being heated by passing through said casing and an exhaust gas of said internal combustion engine.

23. A dehumidifying and air-conditioning apparatus comprising:
a dehumidifier rotor in which moisture from humidified air is captured by hot air; and
a heat exchange element providing heat exchange between at least two flow passages, the air dried by said dehumidifier rotor being supplied to a room through one passage of said heat exchange element, water is passed in another passage of said heat exchange element, wherein the passages of the heat exchange element are isolated such that the dry air in the one passage is prevented from adsorbing moisture from the humidified air in the another passage.

24. A dehumidifying and air-conditioning apparatus comprising:
a dehumidifier rotor in which moisture from humidified air is captured by hot air;
a heat exchange element providing heat exchange between at least two flow passages, the air dried by said dehumidifier rotor being supplied to a room through one passage of said heat exchange element, air from inside of the room, which is humidified, is passed in another passage of said heat exchange element; and
a hot air outlet passes hot air to the dehumidifier rotor, the outlet producing high frequency noise.
